(19) United States
(12) Patent Application Publication
(10) Pub. No.: US 2015/0379604 A1
(43) Pub. Date: Dec. 31, 2015

(54) System and Method for LeafBill

(71) Applicant: Grace Tang, Newark, CA (US)

(72) Inventor: Grace Tang, Newark, CA (US)

(21) Appl. No.: 14/800,655

(22) Filed: Jul. 15, 2015

(51) Int. Cl. G06Q 30/06

(52) U.S. Cl. CPC G06Q 30/0621; G06Q 30/0643

(57) ABSTRACT

A method, apparatus, and system for adding components and/or services to generic products and make the add-ons and their associated costs visible, selectable, and purchasable for consumers. A method, apparatus, and system for services providers to instill add-on components and/or services onto generic products, add and display additional costs on top of the original pricing, so that they can receive the payments upon the sell of said enhanced products. A system and method to create a flexible, visible and transparent way to award individual contributors for their add-on works as part of the sell of an enhanced product.

### BACKGROUND OF THE INVENTION

1. Field of the Invention

This invention relates generally to retail and commerce system. More particularly, the invention relates to a system and method for creating add-on values to enhance products and reward said contribution by third party service providers.

2. Description of Prior Art

Our economics system is vital for the prosperity of human society. Since human starts trading, we have gone through many innovations and improvements to adjust our economics system to our ever changing environment.

The optimized productivity aided by advanced technologies brings many changes into our environment, and requires us to improve our economics system to adapt to these changes.

My invention helps people creating add-on values to enhance products and provide ways to reward their contributions.

The analysis included in this document is based on the observation of the trends of current and future development in various technology fields, various markets, and our economics system. Charts over a historical timeframe are included in this document, they are based on this analysis and assumptions made on top of the observation of facts. It is subject to improvements in the future.

### SUMMARY OF THE INVENTION

A method, apparatus, and system for adding add-on components and/or services to products and make the add-ons and associated costs visible to consumers, providing the means and methods for consumers to select add-on component(s) and/or service(s), and purchase enhanced goods customized with said add-ons components and/or services. A method, apparatus, and system for services providers to instill add-on components and/or services onto generic products, add and display additional costs on top of the original pricing, so that they can receive the payments upon the sell of said enhanced products. A system and method to create a flexible, visible and transparent way to award individual contributors for their add-on works as part of the sell of an enhanced product.

### BRIEF DESCRIPTION OF THE DRAWINGS

For a more succinct understanding of the nature and objects of the present invention, reference should be directed to the following detailed description taken in connection with the accompanying drawings in which:

FIG. 1 is a chart illustrating estimated growth rate for machine productivity and human reproductivity over a historical timeframe.

FIG. 2 is a chart illustrating estimated percentage of exchangeable human resources vs. exchangeable resources produced by machine in our economics system over a historical timeframe.

FIGS. 3A and 3B are charts illustrating estimated efficiency of fulfillment of demands in our economics system over a historical timeframe.

FIGS. 4A and 4B are diagrams illustrating the concept of the formation of optimized productivity.

FIG. 5 is a diagram illustrating the concept of adverse price competition cycle.

FIG. 6 is a diagram illustrating the cost-plus retail pricing model.

FIG. 7 is a diagram illustrating using add-ons to increase the perceivable value of product for customers.

FIG. 8 is a diagram illustrating the Prime Elements of Purchase, and the impact of saturated market on these elements.

FIG. 9A, 9B, 9C are diagrams illustrating product driven market, demand driven market and balanced market.

FIG. 10 is a chart illustrating the market consumption volume for a product.

FIGS. 11A and 11B are diagrams illustrating the concept and methods of price adjustment and price segmentation.

FIGS. 12A, 12B, 12C and 12D are charts illustrating the impact of mass production on the value of product, and the effect of increasing perceivable value of product using add-ons.

FIG. 13 is a diagram illustrating the instilment of add-on values for generic products.

FIGS. 14A and 14B are diagrams illustrating the structure and components of a LeafBill.

FIGS. 15A and 15B are diagrams illustrating two examples of LeafBills.

FIG. 16 is a diagram illustrating another form of LeafBill.

FIGS. 17A and 17B are diagrams illustrating an example of using Leaflet to order and/or purchase add-on services, and using barcode on the Leaflet.

FIG. 18 is a diagram illustrating using a virtual fitting system to select and visualize add-on components and/or features on top of a picture of the consumer's space, make the purchase, and print out the LeafBill using said system.

### DETAILED DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

### The Problem

The intended purpose of money is to transfer value from one entity to another. People need to exchange their services and goods with other people, so that they can receive different services and goods with equivalent and/or similar value. The liquidity attribute of money allows it be carried, stored and transferred among entities with ease. Money is the media that people and entities in human society use to quantify and exchange their resources. It is one of the fundamental elements in our economic system.

### Part 1: The Purpose of Money

Money is used to quantify, measure and exchange for different types of resources. This includes materials, such as diamonds and gold; usage of geographical location, such as a lease owned retail store; privileges in human society, such as membership of certain clubs; visibility in human society, such as publicity among different social groups; and human resource, such as the hours that one person work for another; and many other types of resources. In short, money can be used to quantify and exchange for things in various aspects of what, when, where, why, how and who.

### Part 2: Our Economic

A healthy economic system is based on the assumption that:

Amount of money transferable in the economic system=Amount of resources transferable in the economic system

However, in model age, with the advancement of technology and easy distribution of information, it becomes increasingly easier to produce large quantities of products with little resource. For example, one person with a few 3D printers can print out enough golf balls to supply the entire city.

The accumulation of materials is happening in a much faster pace than the accumulation of time. If we look at the growth rate of exchangeable resources available in the market, we can get a better picture.

With the advancement of technology, productivities are improving at an exponential rate. This was observed in the Moore's Law, that “over the history of computing hardware, the number of transistors in a dense integrated circuit has doubled approximately every two years.” In general, this observes that that the computation power has an exponential growth rate over the years, and this, along with other factors, results in the productivity grows exponentially over the years.

In general, people are being able to make things much easier, faster and better over the years, our productivity has an exponential growth rate. This exponential grow of productivity is powered by machines and/or robots, process automation and computation power; and it is irreversible.

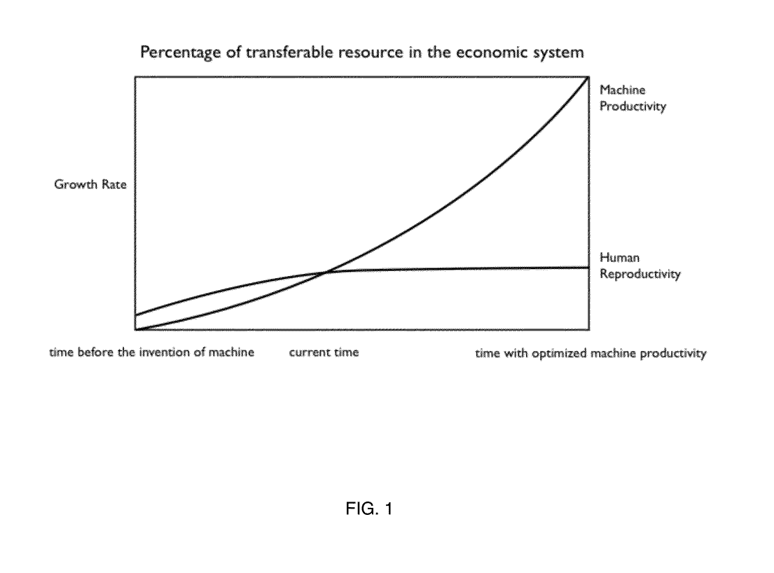

However, compare to machine productivity power, human reproductivity are limited by the organic nature of human beings. A baby needs to be conceived, carried to full-term, born and raised to become an adult who possesses the reproduce power. In modern age, it is quite normal for people to produce kids at age ranging from 20 s to 45 s. If we use 30 years as the average number of years for a human being to produce one kid, or two kids per couple, that is 1X growth over 30 years. And this is assuming that human beings on average, do produce two children per couple. This is illustrated in the FIG. 1.

As we mentioned earlier, money can be used to exchange and transfer time, such as the hours a person works for another, in other words, a portion of a person's life. A person produce qualified working hours only in his/her adult life. This is referred as human resource here.

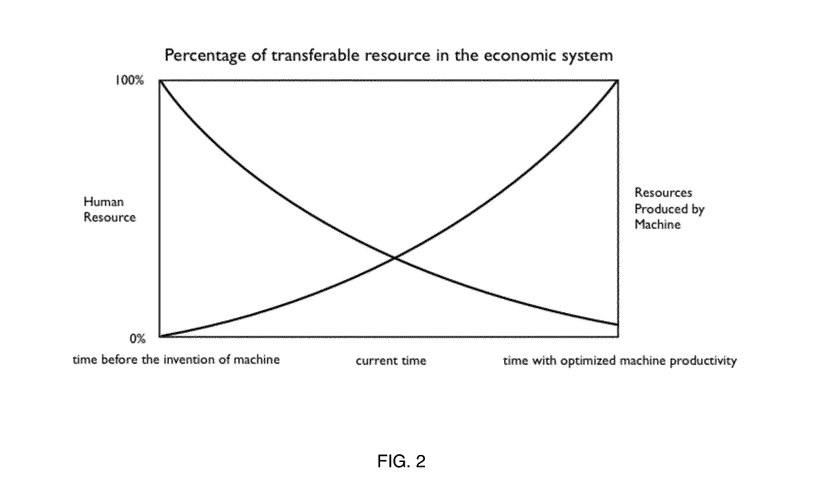

If we look at the entire economics system, that consists both machine made resources and human resources, both are quantified and made exchangeable through money transfer in the economic system, we can see the trend over the historical timeframe, illustrated in FIG. 2.

### Part 3: Adverse Competition in the Market

One of our human nature is that people always want better things at lower price.

With the enhanced productivity, aided by advanced technologies, an increasing amount of products are being delivered to the market. This may disrupts our market and our economics system.

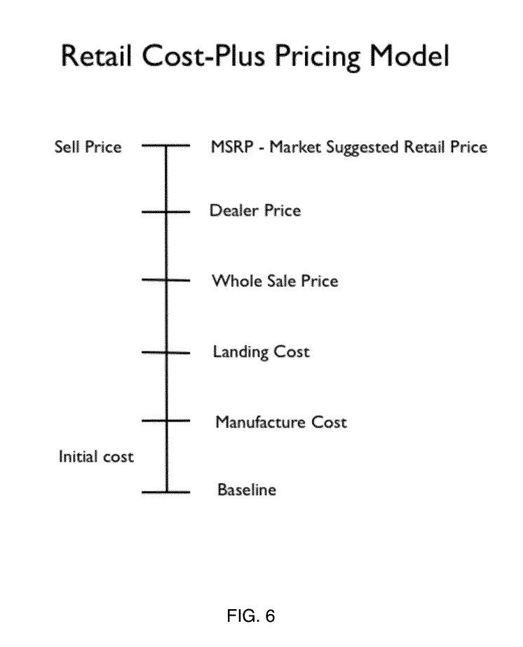

With our current retail system, when a consumer buys a product, he/she pays the price for that product to the retailer. Retailer usually charges at MSRP (market suggested retail price) for that product. Using the money received from customers, retailer refills his/her inventory from the product distribution chain. In turn, each entity along the product distribution chain receives its portion of benefits from the sell as add-on cost. These entities include the designers who designed the products, manufacture who produced the products, logistic company who shipped the products, distributors, wholesalers, dealers, retailers and etc. (FIG. 6)

However, with the boost in productivity and the expansion of mass production, this cycle is being disrupted, and the impacts become increasingly visible in the retail market.

Mass production causes mass amount of generic machine made products available to sell in the market. This intensifies the competition among similar generic products in the market. It also intensifies the competition between retailers.

Retailers are forced to offer the lowest price possible to attract customers. The purchase source (the Who element) of where the customers buy the products no longer matters that much. Consumers can buy the same generic product from multiple places. In most cases, they will buy the products from the retailer who offers the lowest price, and often, the lowest price are offered by online e-retailers.

This disrupts the entire product distribution chain. Because brick and mortar retailers has higher cost, including the cost of the physical store location, store staff, utilities, inventory stocking and etc. Because of these add-on costs of a brick and mortar store, these retailers often cannot offer the lowest price for the same generic products that are also available to purchase online.

Sometimes, manufactures, brick and mortar retailers and e-retailers may reach a consent, and list the same product at the same price both online and in-store. But the net profit from the sell of the same product will be lower for the brick and mortar retailers, because of the add-on costs of their physical stores.

At the same time, if said consented price of said generic product is higher than similar products, consumers tend to find a similar product that is offered on the market at a lower price. The adverse price competition is not only across the same product line, or the same brand, it is across all similar products lines, and all similar brands.

If generic made products only has marginal difference in style, quality and brand recognition, they will be forced to compete in price. Whoever has the lowest price will get the sell.

Because of the brick and mortar retailers have more add-on costs than e-retailers, they often can not offer the lowest price, and can not attract large quantities of customers by selling generic goods at a higher price tag.

Without a healthy sales flow, their inventory is stocked up in the store for a long time, and become out of trend, which makes it even harder to attract customers to come to their store to purchase these out of trend generic goods. Retailers' working capital gets tied up by these generic inventory goods that can not sell, and don't have enough free cash flow to refresh their inventory. This situation is getting worse with the passing of time.

This adverse competition in pricing also causes another serious problem.

Because prices are pushed down to as low as possible, most retailers tend to offer generic machine made products at cost. The competition in price turns into a competition in cost. This significantly limits how much human resource they want to invest in their products, to lower the cost of mass produced generic products. And most seriously, this decision leads to reduction in labor cost, and reduction in human resource employed in the production, distribution and retail chain.

This pattern matches with the pattern in FIG. 2, that in our economic system, transferable and/or sellable goods will require a lesser and lesser percentage of human resource contribution.

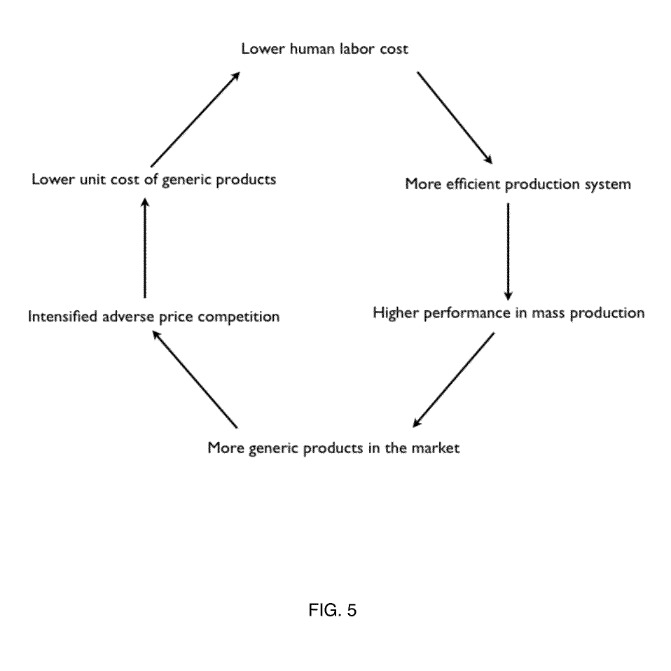

In FIG. 5, it shows that with advance of technology, the production system becomes more efficient, and enables higher performance in mass production. This creates more generic products, mass produced by machines, delivered to the market, and ready to sell. Because the market is limited by its consumption rate, the abundance of the generic products in the market reduces its scarcity, lower its perceivable value to the customers, and intensifies the price competition to induce sell. The harsher price competition leads to lower unit pricing of said generic products, and leads to reduction of human resource involved in the production, distribution and retail chain. This in turn, creates more incentive to improve the production system using advanced technology, to make it more efficient in producing more products with less resource.

It is an adverse cycle keep evolving, intensifying the competition in the market, driving down prices, and reducing resources involved in the process. This cycle is adversely affecting the retail market, deteriorating the market condition, and forcing many retailers out of business.

### Part 4: The New Generation of Products

Aided by advance technology, our productivity is increasing at an exponential rate. Not only there is any exponentially growing amount of finished products being delivered to the market every year, but also the repair and/or replacement of these products are much easier. As damaged product can easily be repaired and/or refurbished into like-new condition.

For example, if the original product is assembled with parts created with 3D printing, it will be very easy to print out that part of the product using 3D printing, and replace the damage part with the newly printed one. Since both parts are printed out using the same 3D model, it will be a perfect match.

Thus the new generation of products may always in like new condition. They are easy to duplicate, easy to repair, easy to clean, easy to maintain products, and they will be created in massive quantities.

If a product is printed using recyclable materials, the cost of melting an old product into its original material form, purify it, and reuse that material to print out a new product will be very easy. In this case, we will always have new products to use. This means that this new generation of products will have unlimited shelf life, unlimited product life span, and will already be ready to use at brand new condition. They have many advantages over older generation of products.

### Part 5: Optimized Productivity

We are at an age when technologies are advancing in an increasing faster pace in multiple vertical. Computation power, 3D printing, robotics, artificial intelligence, material science and many other fields are all advancing at a fast pace. If we look into it, we will find that a super production power are being incubated, and will be formed.

This super production power will enable optimized productivity, and bring it into the market. It will be enabled by 3 major advance technologies.

The 3D printing technology can print out massive amount of components, created with various 3D models designed to fulfill specific needs. 3D printers can print out these components anytime at anywhere.

Robots and automated assembly lines can be used to assemble these components, and put them together into final products.

Computation power can be used to control the 3D printers, robots, and the assembly lines, to manufacture, packaging and deliver these products to customers.

With the combination of these three advanced technologies, we can achieve optimized productivity. This is illustrated in FIGS. 5A and 5B.

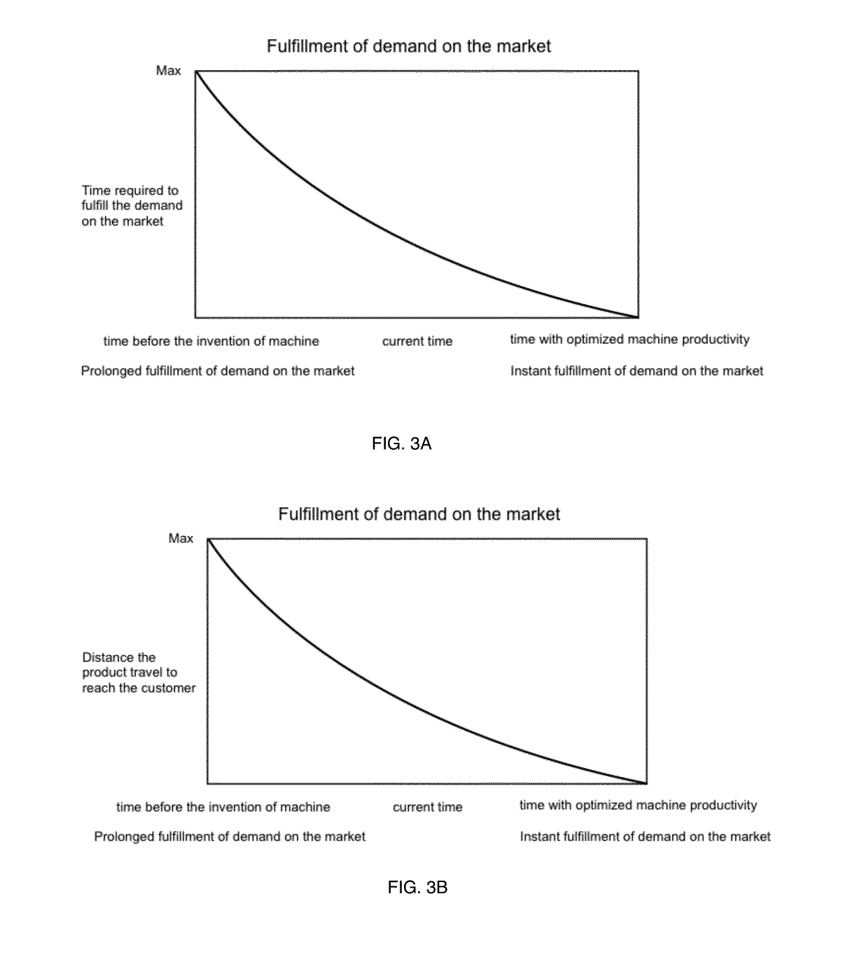

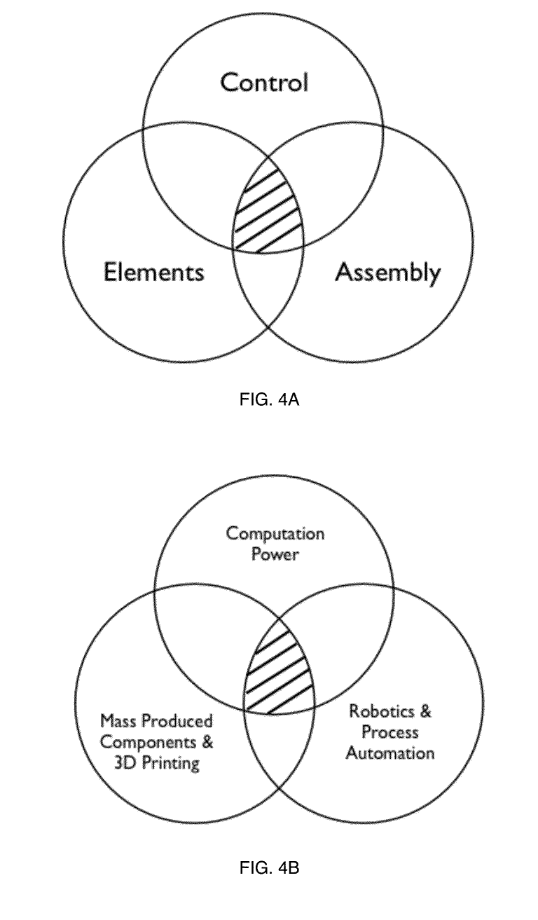

At the time when optimized machine productivity is reached, theoretically, machine can produce all the materialized products in our economic system. Theoretically, the ultimate result is that all materialized products that can be consumed in our economic system, can the generated through machine at the moment when such needs arise, and make available to the consumer at the place where they need it. This is an instant fulfillment of demand on the market, or in other words, a fully satisfied consumer market. This is illustrated in FIGS. 3A and 3B.

### Part 6: Prime Elements of Purchase

Like water, for it to flow from one place to another, there must be a reason. Water finds its way from the top of the mountain to the bottom of the ocean, because there is a gap in the elevation, and water are attracted by gravity.

For a money transaction to take place, one party want to exchange money and/or resource with another party, it needs to have its reason. We commonly call this the incentive to purchase or the reason to buy.

If we look at what are these reasons, we can summarize them into 6 major elements, including the uniqueness of the product, what to buy, time to buy, location to buy, how to buy and buy from whom. Interestingly, it is covered by the six prime elements of purchase What, When, Where, Why, How and Who.

People want to buy things that they don't have. In ancient time, this is the reason why merchants travel long distance to purchase salt, and trade them inland at a much higher price, because it is hard to find salt at places far away from the sea. It takes time to travel long distance, there is a gap in the market to ensure the transaction can take place. Because people are willing to use money to trade for the resources. In its physical form and/or its tangible asset, the product is salt. What's also included in the product and the transaction are the intangible assets, the underneath add-on value, that is the time and resource the merchant spend to travel the distance to obtain the salt.

For the clarity of this document, the mass produced generic products are made by machine.

With advanced technology, people can create generic products with ease. Just like people can download a picture from the internet and printed it out on a paper in seconds anywhere in the world; it will be very easy for people to download a 3D model data file from the internet and print it out using a 3D printer in the future, anywhere in the world.

This means generic products can be easily made by anyone, anywhere in the future.

This means that the market gap for generic products is narrow. Because anyone can print out generic products at anywhere, people don't need to order it from vendors far away, they can order it from print shops in their neighborhood, or print out easier ones at home. The time, distance and how elements for the transaction to occur are removed.

Generic products are duplicated copies, the uniqueness element and/or the What element for the transaction to occur are removed.

Anyone will be able to print out generic products, so the Who element for the transaction to occur are removed.

Why will a person buy things from other people if they can produce them themselves? People want to buy things that they don't have, they don't want to buy things that they already have. So the Why elements for the transaction to occur are also removed.

With optimized productivity, entities in our economics system are self-sustainable, and we can use the productivity to produce generic products locally.

But with optimized productivity, all Prime Elements of Purchase, and/or elements for a transaction to occur are dissolved, except a few fundamental exceptions.

Our geographical locations are unique, our natural resource allocations are unique, our culture is unique, and our human resources at each location are unique.

### Part 7: Productivity and Consumption

While productivity power aided by machine can be increase exponentially, and limitlessly, human beings are limited by our organic physical forms.

Our bodies are organic; we have a limited life span. We can eat a limited amount of food everyday, consume a limited amount of energy everyday, and although our minds, voices and images travels freely through the internet, our physical body are located at one place at a time. As a consumer, we can consume a limited amount of resource everyday.

This means that the consumption power is limited in our economics system. It is limited by the human population in this world, and it is limited by how much resource human beings can consume everyday. While global human population growth amount to about 1.1% per year, it is noticed that more developed countries have lesser growth rate. With the advancement of the technology and its distribution to less developed countries, it is possible that the birthrate of human population is in the vicinity of replace rate in the next century.

Although human consumption rate may stabilize, our productivity has an exponential growth rate, aided by advanced technologies. Human productivity will outpace human consumption at some point of time in the future.

In our economics system, the value and/or asset transfer is completed when a product is consumed. Without consumption, transaction will not take place. This means our economics system will sustain enough transactions such that all consumption will be fulfilled by productions. Our economics will be stabilized and balanced at a threshold that is defined by human population's consumption rate.

Amount of Sellable Products=Amount of Consumable Products

### Part 8: Market Types

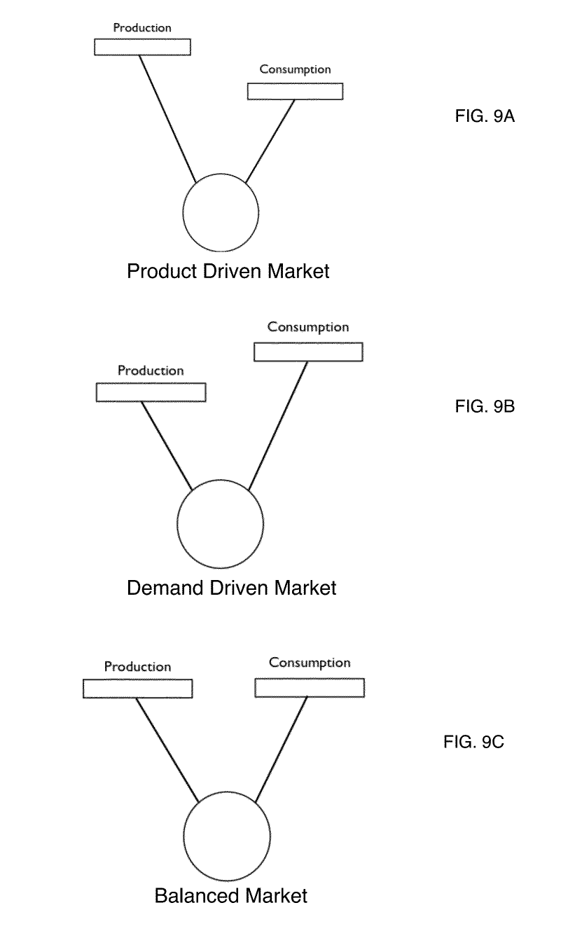

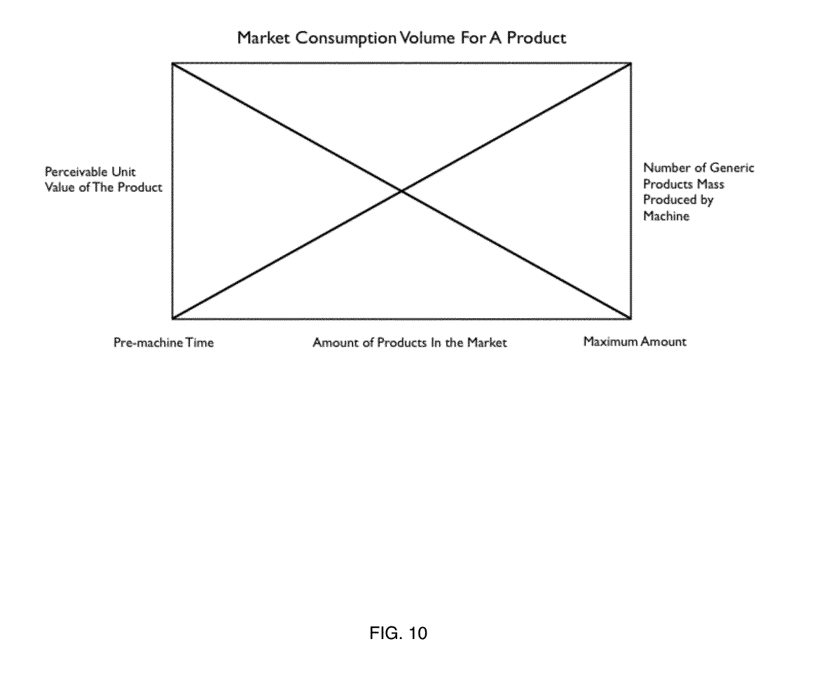

In a product driven market, there are many consumers seeking products to fulfill their needs (FIG. 9A). The transaction volume depends on how much products are available on the market to fulfill the needs for said product. As soon as the product is manufactured and made available to the market, it is brought by a customer who is waiting for said product. There is a market demand for products that are in-need, the driven factor on the market is the availability of the products. Merchants proliferate in transactions through customers' perceivable value of the product, which is partially determined by the scarcity of the product.

In a demand driven market, there are more products on the market and they have to compete for customers for transactions to take place. Merchants seek out the customers who are willing to pay for a product. Merchants proliferate in transactions through customers' perceivable value of the product, which is partially determined by the willingly of the consumer to pay for said product. (FIG. 9B)

In a balance and/or saturated market, consumer demands on the market are fulfilled by production instantly and locally. The market gap is narrow, and can be fulfilled and balanced soon after it shows up. (FIG. 9C)

### Part 9: GDP

Gross domestic product (GDP) is defined as “an aggregate measure of production equal to the sum of the gross values added of all resident, institutional units engaged in production”. GDP estimates are commonly used to measure the economic performance.

GDP can be determined in three ways, all of which should, in principle, give the same result. They are the production approach, the income approach, or the expenditure approach.

According to Wikipedia, the most direct of the three is the production approach, which sums the outputs of every class of enterprise to arrive at the total. The expenditure approach works on the principle that all of the product must be bought by somebody, therefore the value of the total product must be equal to people's total expenditures in buying things. The income approach works on the principle that the incomes of the producers must be equal to the value of their product, and determines GDP by finding the sum of all producers' incomes.

In a product driven market, the production approach is commonly used to measure the economic performance, because the balance of transferable resources in the economic system is limited by the amount of produced products in the market.

In a demand driven market, the income approach and expenditure approach need to have the focus. Because the balance in the economic system is limited by the amount of consumer demands and/or amount of resources available for the consumers to make the expenditure.

Amount of Sellable Production=Amount of Consumption

Investments such as stock exchange should not be included as part of Consumer Consumption. They are like bypasses in our circulation system inside a person's body, blood (money) flow through these bypasses, but do not slow down to deliver the nutrition and oxygen to our cells.

In its original design, all three ways to measure GDP shall give the same result. However, with the exponential growth of productivity, the production approach will have a higher grow rate than the income approach and expenditure approach, as indicated in FIG. 1. This gap between production approach, income and expenditure approach will be widened with the advancing of new technologies and time, its impacts will become increasingly visible in our economy.

### Part 10: The New Market

What will be the new market? What make people want to buy things from another entity? It comes down to the fundamental question: Why people buy?

People want to buy the things that they don't have, that make them looks better and feel better about themselves.

We are each unique beings, always seeking things to improve our lives. Because we are unique, the ways we look at things are unique, the ways we think about things are unique.

In a saturated market, things that we can easily have such as generic products lost their scarcity for us. We want interesting things that we make us feel special about ourselves. Time and environment will not change our nature, that we human beings, like to explorer things and possess things that make us feel better. And that's the engine for commerce in this new market.

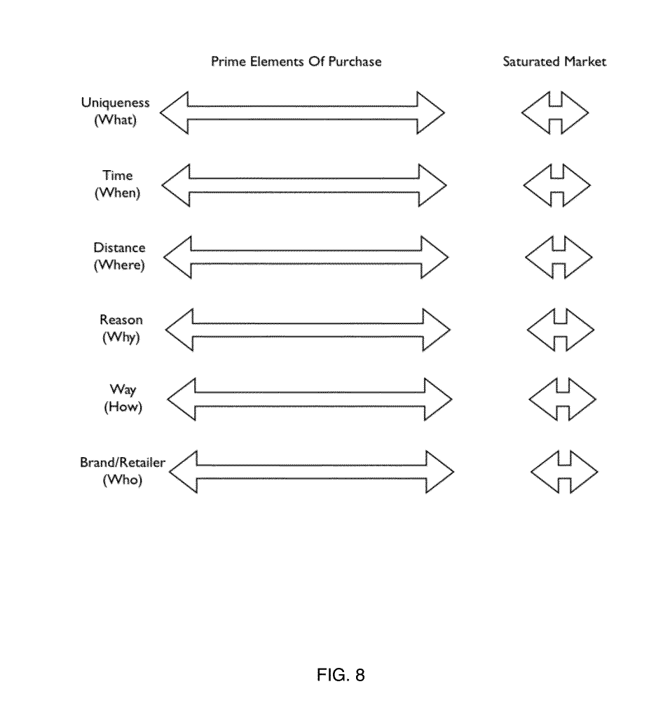

If we look at FIG. 8, in this new market, the transaction will still be governed by the six elements What, When, Where, Why, How and Who.

Our incentive to buy will be based on the uniqueness of the product. How unique a product is, whether it make that consumer looks better and feels better will decide whether he/she wants to buy that product.

Although consumers can print out generic products at home, we human being are social beings. We like to associate with people, and receive services from other people. We are physical beings, this limits where we can receive services in person. For example, a local restaurant has regular customers visiting the restaurant, because people have to be physically present at the restaurant to eat. A makeup artist has regular clients, because people put makeup on their faces. This can be concluded as local service providers that provides customized, in person services. These are the When, Where, How and Who elements of the Prime Elements of Purchase.

Now, for products to differentiate themselves from generic products, they need to be unique. Either they are customized or tailored to specifically suite the needs of individual customers, or they have a design, feature or character that make them different from generic products mass produced by machine. This needs to be solved for the What and Why Elements of Purchase. There are and will be many techniques to solve this.

### Part 11: A Healthy Economy

A healthy economic system is based on the assumption that:

Amount of money transferable in the economic system=Amount of resources transferable in the economic system

In an balance market, where the consumption limits the amount of transactions take place in the economic system, it will be very important to ensure that the we have a healthy consumption in the economic system. Because the more consumption consumers make, the more transactions in the market, the more affluent the market. Just like a human being has blood constantly circling inside his/her body, and keep all body parts nurtured and alive. A healthy economics system needs constant circling, refreshing, allocating and rearranging resources to keep healthy, for all parts of our society to prosper and stay alive. It needs abundant energy in the market to take place to achieve this goal. People exchange with other people for resources so that we will all have a full spectrum of resources that we need, so that entities in our society can stay healthy and prosper.

By our organic nature, because we human live, travel and entertain, we create consumptions in our economics system. This is different from machine. For machine, once they are produced, the cost of maintaining a machine in its working state is very low. In the future, when the energy cost is low, the cost of running and maintain a working machine is almost zero. Thus a working machine does not generate consumption in our economics system.

In a demand driven market, or a balanced market, the health of the economics system will be determined by our consumption, which means it will be determined by how much human beings consume. The better living standard we have in our society, the healthier consumption, the better economy.

To ensure this healthy consumption, we need to ensure that all human beings have the access, incentive and means to exchange resources with other people.

We, human beings, like to have things that make us look better, feel better about ourselves. We, human beings, like to work on things that we are interested in, things that make us unique. And things make us unique are not mass produced by machines.

The solution is created when we provide the means for a common person to transfer his/her unique tangible and/or intangible assets into products, or infuse them as add-ons of generic products, make it transferable, so that people can easily exchange them with other people, and receive the benefits for their work and effort.

This is the reason for this invention.

### The Solution

### Part 12: Price Segmentation

In ancient times, pearls were very rare, and hold a high value, and were used to exchange for diamonds and precious stones. Then human finds a way to mass produce pearls using oyster farms. Since then, the price of pearls dropped significantly, because they are not scarce any more.

For mass produced products, the same rule applies. Mass production causes the products to loss their scarcity. If one thousand glasses are mass produced and selling on the market, and there are only five hundred people in the town, these glasses will overload the market. Not only the glasses could not hold its value, but also it disrupts the market and waste the resource it is taken. Because it takes resource to produce and stock these glasses. When the glasses can not sell, they hold these resources in a congested state, as stagnant inventory piled up in the warehouse. It is like the fat accumulated on a person's body, once it gets there, it is hard to trim off the fat. The more fat one has, the heavier the body, the harder it gets to exercise and stay fit.

More importantly, these congested mass produced products cause the human resource instilled into these products stay in a congested, unpaid state. If a factory can not sell its products for a long time, it can not pay its employees. If a store can not sell its products for a long time, it can not keep its business afloat, and will have to close business. Human beings can not live without resource. We are organic beings that need constantly consume resources to stay alive.

To solve this mass production issue, we have to separate the mass produced assets from the tangible and intangible assets instilled by human in the product. And we have to adjust the price of the product based on its scarcity.

This way, we can compensate and improve the value of human's work, while adjusting the unit value of the mass produced part of the products to maintain a healthy economy.

There are multiple ways to segment and adjust the price of the product based on its scarcity, and provide an organic way to prevent market congestion.

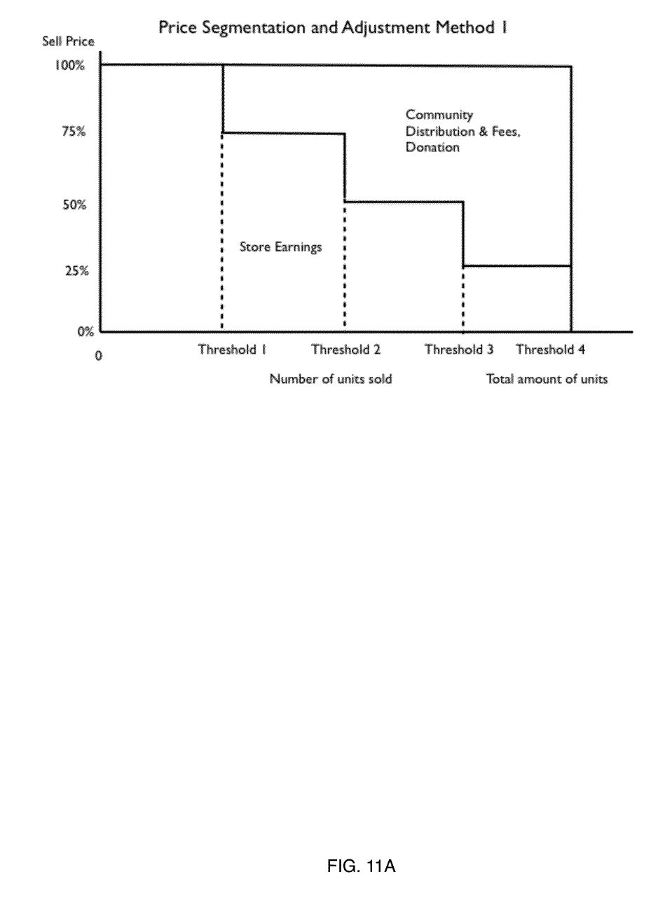

Two methods are illustrated in FIGS. 11A and 11B.

In FIG. 11A, the selling price of a generic product is adjusted based on how much volume has been sold.

For example, if a town has 100 people, and a seller and/or retailer has a batch of 100 generically made glasses for sell. In FIG. 11A, if each threshold is set at 25% benchmark, for the first 25 pairs of generic glasses sold, retailer gets 100% of the sells price. For the next 25 pairs of generic glasses sold, retailer get 75% of the sells price, and distribute 25% to community fund. For the 51^{st} to 75^{th} pairs sold, retailer get 50% of the sells price, and distribute 50% to community fund. For the 75^{th} to 100^{th} pairs sold, retailer get 25% of the sells price, and distribute 75% to community fund. If the retailer restocks inventory, and sells more of the generic glasses at the same town, which means he/she is overloading the local market. Because now the number of glasses sold and are being sold is more than the population at the local community. In this case, 100% of the sell goes to community fund for the additional pairs.

This deteriorates people from overloading a local market with generic products at a pace faster its consumption rate for said products.

In FIG. 11B, the money gained from selling a generic product is divided into two parts, one part to the retailers and/or seller, and the remaining to a community fund and/or non-profit organization (donation and/or tax). Initially, the seller gets 100% of the sells price out of the sell, but gradually, he has to distribute more and more percentage of the sell to the community fund. The division is based on how many units he has sold, divided by the number of units he has stocked for that generic product.

Assume a batch of generic products has 100 items, priced at $100 each. The total gross sales income for this batch of generic products is $10,000.

In FIG. 11B, for the first item sold in the store, $100 (100% of the net sale) will be allocated to the seller and/or retailer, $0 (0% of the net sale) to the community fund. For the second item sold, $99 (99% of the net sale) will be allocated to the seller, $1 (1% of the net sale) to the community fund. For the last item in this batch, when it is sold, $0 (0% of the net sale) will be allocated to the seller and/or retailer, $100 (100% of the net sale) to the community fund.

This provides an organic way to control inventory overflow in the market, and also provides a resource for community fund and/or fees.

### Part 13: Add-On Values

The perceivable value of products can be significantly increased through add-on components, features and product customization.

In a demand driven market, the when, where, how and who factors no longer limits how consumers make their purchase decision. One way for products to stand out and make strong sales, is to be customized or tailored to specifically suite the needs of individual consumers. They may have a design, feature or character that make them different from generic products mass produced by machine. This boosts the What and Why factors to induce the purchase.

When a distributor and/or retailers offer high quality on-going service, to customize and tailor the products to suite the needs of individual customers, they attract more customers to visit their stores and buy from them. This boost the when, where, how and who factors in the Prime Elements of Purchase.

Most importantly, these customized and tailors services are often have creative elements, and require sophisticated inter-personal skills. These services are provided by store assistants, service providers, and/or other human resources. These services offer abundant work opportunities for human workers.

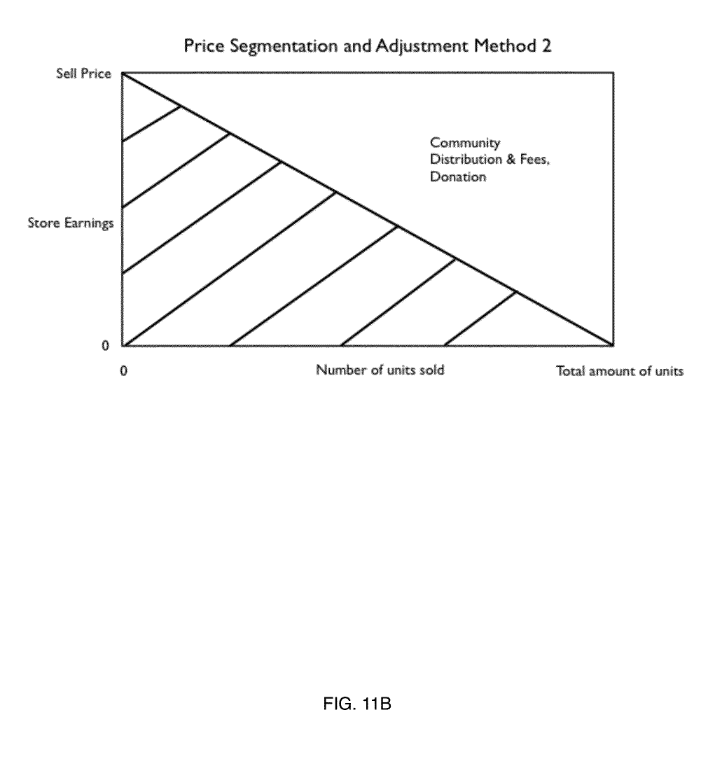

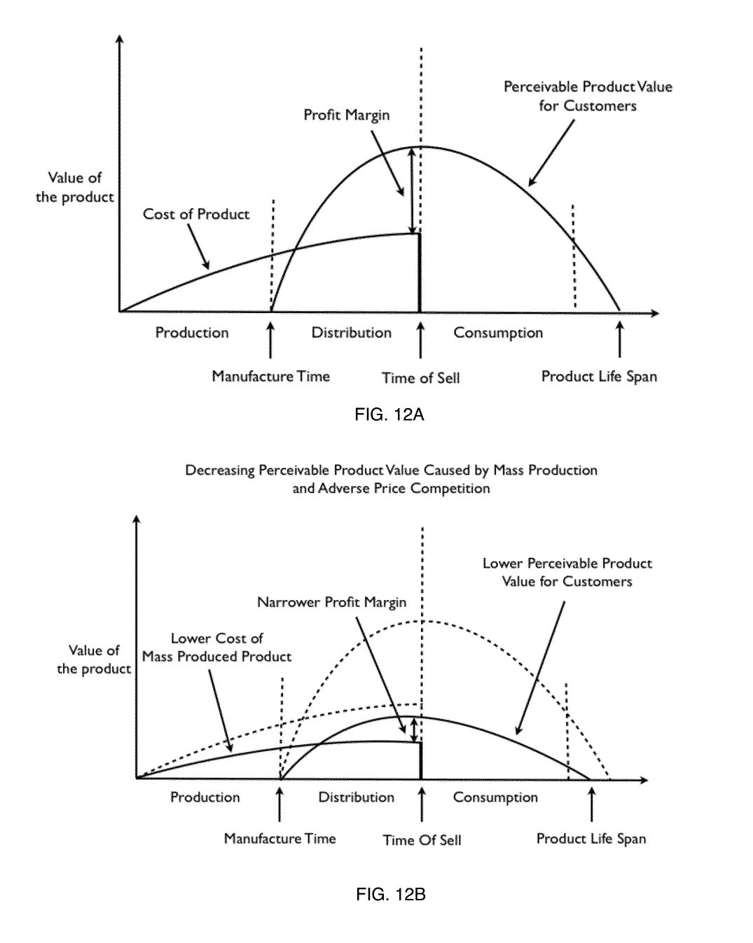

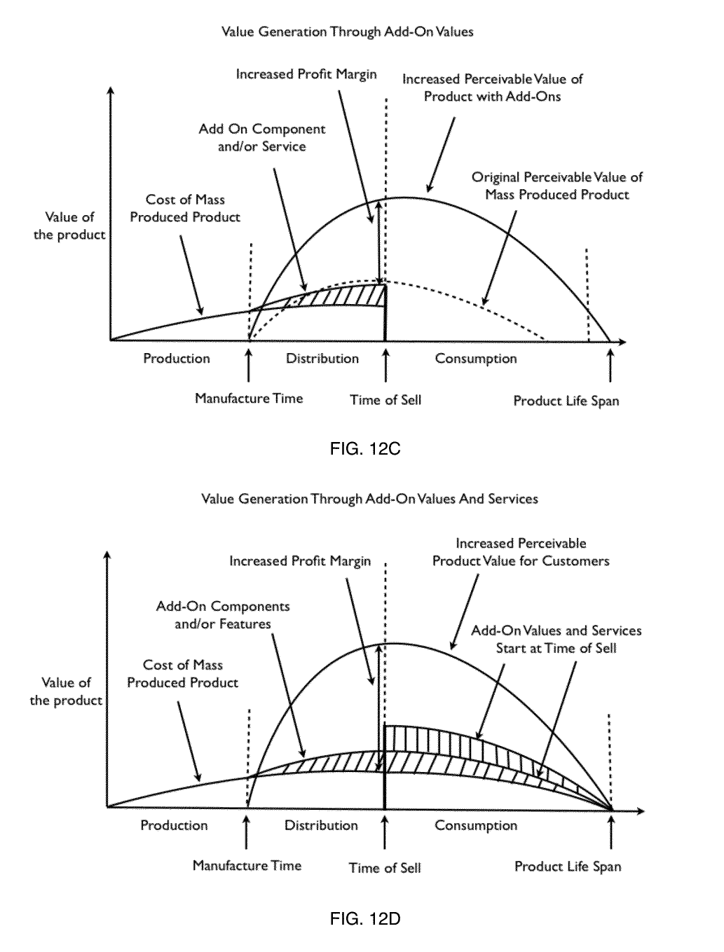

In FIG. 12A, the value of the product during its production, distribution and consumption phases is illustrated. When a product is manufactured, the cost associated with designing, producing, distribution, storing the product and etc are added on top of the original cost of the manufactured product, until the Time Of Sell. When a customer has perceivable value of the product that is higher than the cost of the product, and the product is ready to sell, and the customer has the access to purchase the product, the purchase takes place, this is recognized as the Time of Sell. The Prime Elements of Purchase are met at the Time Of Sell, that is what, when, where, why, how and who are all matched from both the consumer side and the seller side. The retailer at the Sales Point receives the net profit from the sell, which is the amount of money he/she receives from the customer, minus the cost of that product and the cost associated with the sell.

Profit Margin=Purchase Price−Costs Of Sell

Under the pressure of adverse price competition, illustrated in FIG. 5, and mass production aided by advanced technology, the unit cost of the generic product is lowered. This is caused by the higher efficiency in production, as well as a process of reducing resources added in the production, so that a lower cost product can better compete in the market.

Illustrated in FIG. 12B, this adverse competition in the market also causes a lower perceivable value of said product for a consumer. Because the mass produced product not only lost its value in scarcity, but also the quality of said product is lowered, caused by the reduction of resources in the production process.

For retailers, these make the products harder to sell, and also reduced the profit that they can get at Time Of Sell.

In FIG. 12C, add-on components and/or services are added to the generically produced product during the distribution phase, and increase its perceivable value for the consumers.

In FIG. 12D, add-on components and/or services are added to the generically produced product during the distribution and consumption phases, and increase its perceivable value for the consumers.

When customer buys product from seller at a Sale Point, all prime purchase elements are met, it is a contact point where both parties reaches agreement for the transaction to take place. It is also a good place to use add-on values to increase the perceivable values of the products. This is because the Where, How and Who elements are already set and met successfully at said sales point, and by making efforts on the What, When and Why elements, the seller can create add-on sales from existing sales, and/or generate new sales.

We human beings are social beings. We like to associate with people, and receive services from other people. Since we are physical beings, we have limitations on where we can receive in-person services. This can be concluded as local customized in-person services.

With advanced technology, it is foreseeable that many jobs that only have repeatable simple procedures will be replaced by robots. However, many jobs that requires high level of creativity, sophisticated inter-personal skills, personalized preferences and style still requires human beings to do the work.

In FIG. 12.D, the distribution and consumption process are transferred into a value generation process, which allows distributors, retailers and service providers to cooperate with the customers, add values to the product based on customer's preference and taste, and create a higher perceivable value for the customer.

This also increase the profit margin of the sell, and enables the parties that created these add-on values to receive compensations and/or rewards for their work. The majority of these add-on value payments and/or profits will be toward human labors offered by the service providers.

An example of this model is the DIY (Do It Yourself) clay painting retail store. This retailer provides a large amount of paintable clay models and in their stores, including vase, plate, animal sculptures and etc. Customers come to the store, select a clay model for their occasion, paint the model at the store using the painting kit provided by the store. After they are done with painting, they leave the painted clay object in the store for the store stuff to complete the finishing coat on the clay object, and burn it into a final product. The customer comes back to the store and pick up the finished product in one week.

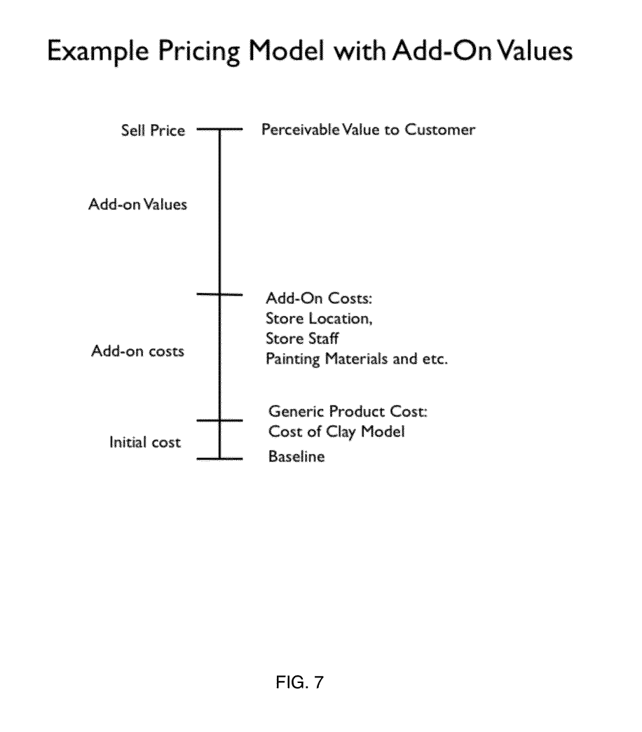

The store charges for the clay model and customers' time spent at the store. In this example, illustrated in FIG. 7, the cost of the mass produced generic product, which are the clay models, is very low. The customers are involved in the creation of the add-on values for the product, facilitated by store staff and resources. They adjust the product to their personal preferences and tastes, using the product customization kit provided by the store. This significantly increase the perceivable value of the product to the customer, they are willing to pay a premier price for the finished products. This is because these products now are instilled with their personal preferences, their personal experience. These products are dear to their hearts now.

The retailer receives a bigger profit margin by selling these customized products that has high perceivable value to the customers. The majority cost of the sell is to maintain the physical store location, store staff, painting material, clay models and etc.

### Part 14: Solution—LeafBill

The principle of this solution is that by adjusting the allocation of the distribution of the payment received from the sell of a product, we ensure that the human resource instilled into the product are compensated and paid. This in turn, ensures that these human assets will be recycled back into our economics system through human consumption.

Another principle of this solution is that by inserting add-on values as LeafBills on top of mass produced generic products, we provide a easy and visible way to add and instill add-on services and product components in the product distribution and consumption phases, and compensate for the add-on work at the Time Of Sell.

Another principle of this solution is that by adjusting the price of the product based on the number of units sold and/or the market demand for said product, we create an organic way to control the disruption of the market by mass production aided by machine.

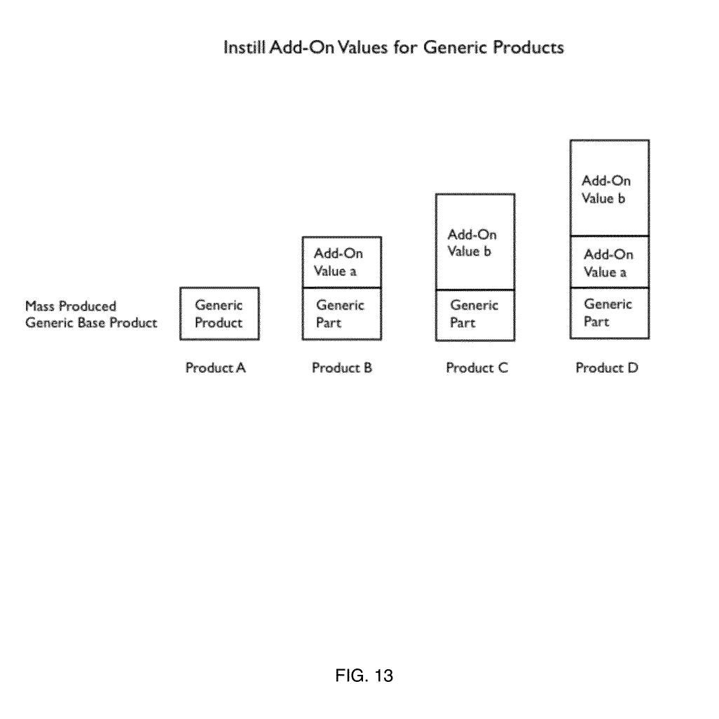

FIG. 13 illustrated that add-on components and/or services are instilled onto generic mass produced products. In this case, generic products serves as a media, it carries the specific add-on features, components and services, delivers them to the customers, to fulfill specific needs of customers. By combining different add-on value and/or add-on value sets with the generic products, and make them available to purchase in the market, we provide a flexible, customizable and adjustable product suite to the customers. This significantly increases the perceivable value of the products to the customers. Now these products are not only functional products, but are customized and tailored based on consumers' preferences, and fits into their personal styles.

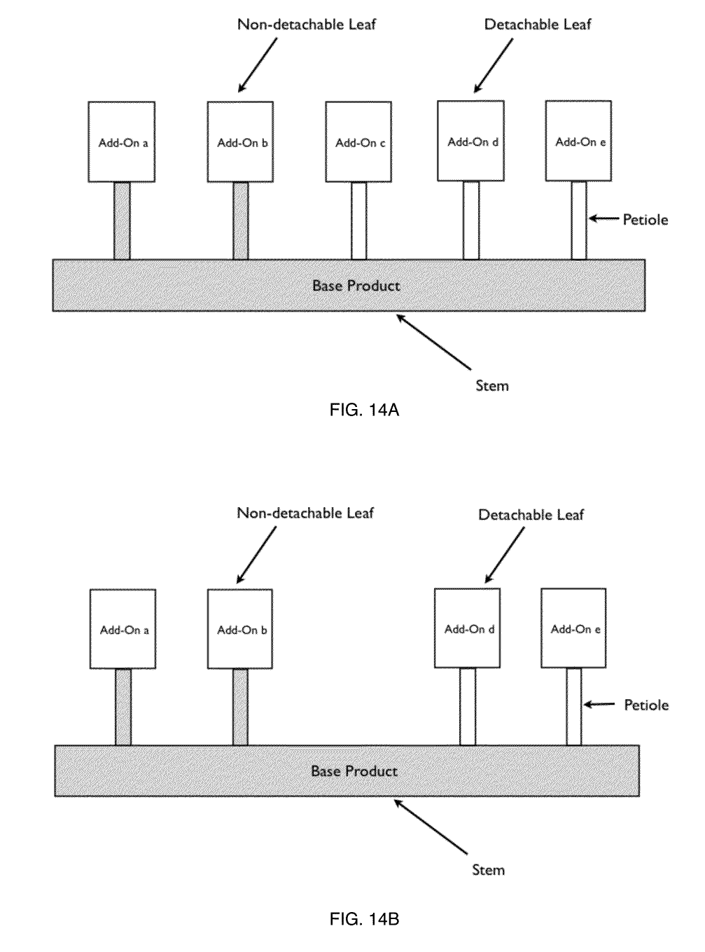

FIG. 14A illustrated a way how the add-on values can be instilled onto a generic product. For this structure, I named it “LeafBill”, and/or “PolyBill”. Just like a leaf have leaflets, petiole and stem; a LeafBill has leaf (leaflet) and a connection part (petiole) that connects itself with the base product (Stem).

A LeafBill is a set of tags, combined into one visible pricing component that serves as a new form of price tag in a retail environment. It lists add-on components and/or services of added onto an otherwise generic product, their add-on costs, based price of the generic product, other related information and the total price for the enhanced product.

It allows the customers to easily view, compare and select add-on components and/or service to purchase along with the generic product, and pay for said add-ons as separate payoffs to add-on service providers, and pay for the generic product to retailer, in one transaction at the Time Of Purchase. It allows the service providers to instill enhanced components and/or services as add-ons of products to increase the perceivable value of said product, and receive compensation for their work at Time Of Sell.

A LeafBill contains one or more Leaves. Each Leaf represents one add-on that is instilled into the product. It contains the cost of the add-on; title and/or short description of the add-on; service provider of this add-on; contact information of the provider; and other related information of the add-on component and/or service.

Each Leaf is attached to the LeafBill through Petiole in two ways, one is non-detachable add-on, and the other way is detachable add-on.

For an add-on component and/or service that has been instilled into the product, and can not be easily removed, that add-on component and/or service is included as a Non-detachable Leaf in the LeafBill.

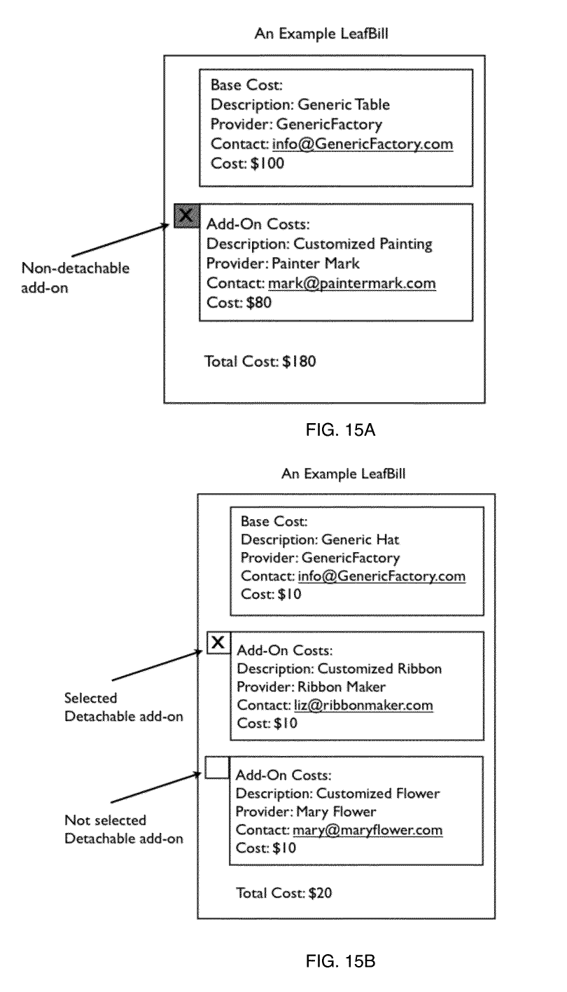

For example, if the product is a piece of furniture. A service provider has painted said piece of generic furniture with enhanced color themes at the store, to match with a customer's personal taste. This added on service is now part of the product. The product now needs to be purchased with the original generic furniture, along with enhanced painting service. As illustrated in FIG. 15A, this add-on service of painting is included as a Non-detachable Leaf of the LeafBill, the original generic furniture cost is included on the Stem of the LeafBill. Customer needs to pay the total cost of the LeafBill at checkout, which is the cost of the original furniture (Stem) and the cost of the customized painting (Leaf).

An example of a Detachable Leaf is a customer want to buy a hat in a store. The store sells a collection of varies hats. One of the hats has two add-on components attached onto the generically made hat, one is a flower, and the other one is a ribbon. Both these add-on components are included as Detachable Leaves on the LeafBill. The customer likes to have the ribbon on the hat, but does not like the flower. So when she purchases the hat at the checkout, she requested the store clerk to remove the flower from the hat, and its Detachable Leaf from its LeafBill. As illustrated in FIG. 15B, the customer only needs to pay for the Stem and one Leaf on the LeafBill, and purchases the generic hat with the ribbon add-on as the final product.

The Detachable and Non-detachable feature of LeafBill makes it very easy to assemble and instill customized components and/or services into the product, and ensure the provider gets paid for his/her work. This allows ample opportunities for service providers to instill add-on values into generically made products, receive benefits for their work. At the same time, they help increase the perceivable value of the products for the customers, and attract the customer to purchase the products at a higher price. This may be the full-time or part-time job for the service providers.

The Petiole of the Leaf in the LeafBill allow the Leaf to be attached onto the Stem, which means it is the part to establish the relationship of a component and/or service, being added onto a product, and become part of the enhanced product, and make it payable at Time Of Sell.

The Petiole represents the partnership between the store owner and the service provider. It can be a non-detachable petiole or detachable petiole, depending on the type of customization and/or service.

The store owner gives the service provider the opportunity to sell their add-on components and/or services on top of their generic inventory. The service provider gives the store owner the opportunity to sell enhanced products at a higher price, attract customers and induce sells. It is a mutual beneficial partnership.

The service provider may pay the store owner a certain percentage from the sell of the add-on components and/or services, for store's cooperation and facilitation in the transactions, the displaying of the enhanced products to the customers, and other resources provided by the store. In this way, the store sells enhanced products at a higher price and gets a larger profit margin, and also receives benefits and/or commissions for the add-on components and/or services. For the store, these benefits and/or commissions are pure profits, and it does not incur additional cost for the store.

The service providers shall refine their styles, techniques and skills. So that they can establish unique add-on components and features to attract customers to make the purchase for the enhancements and/or services offered by them. They not only have a high level of creativity, refined style and taste, but also have sophisticated inter-personal skill. They are the local service providers and/or specialists, have their own customer base, and attract customers to the stores that have their enhanced products on display. These service providers and/or specialists may visit local stores in turns, helping local stores display and promote their enhanced products, and assist store in sales promotions, attract customers to the stores, and increase sales.

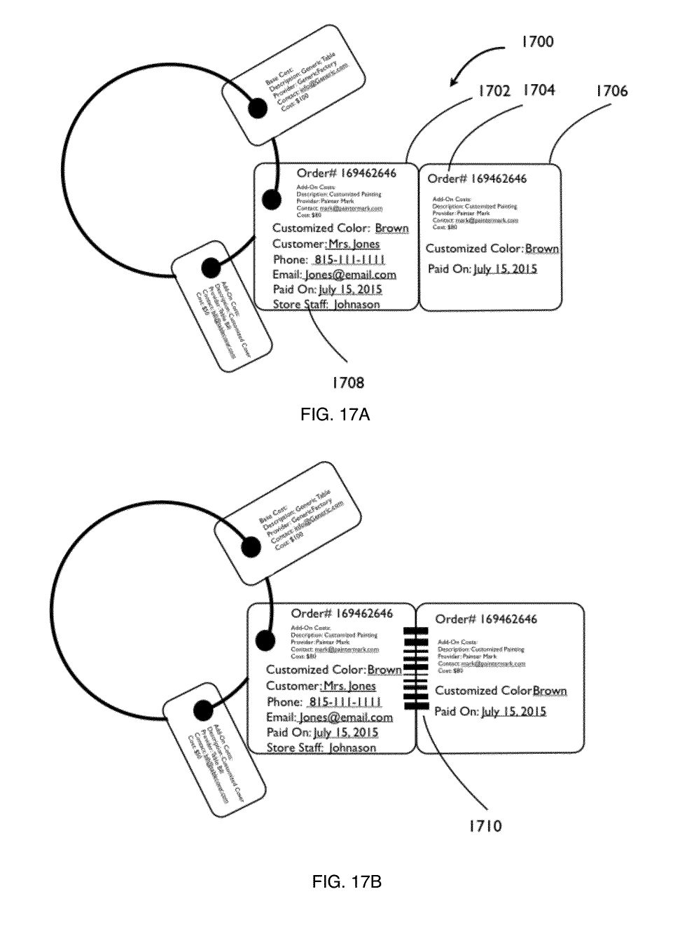

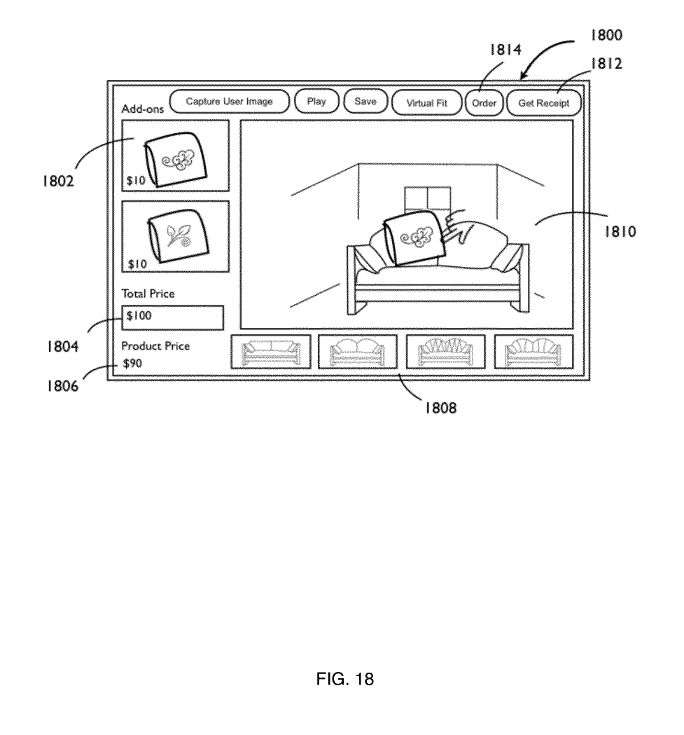

FIG. 17 is an illustration of Leaflet 1700 for the order of an add-on service that the customer purchased with the enhanced product. A leaflet 1700 has two parts, one part is the receipt for the service provider 1702, and the other part is the receipt for the customer 1706. When the customer purchases the to-be-completed add-on service at the checkout, he/she pays for said service along with all other product and/or components included in the LeafBill. Because this add-on service still needs to be completed by the service provider, the customer needs to get a receipt as a proof for his/her payment for said service. Both the service provider part of the Leaflet 1702 and the customer part of the Leaflet 1706 has the same Order Number and/or Receipt Number 1704, to validate the transaction. Customers fill in his/her contact information and customized request for the add-on service on the Leaflet 1708. The store clerk fills in the payment date to warrant that the add-on service has been paid for, and his/her name to validate the transaction. Customer tears out the customer part of the Leaflet 1706 and leaves the product at the store for the service provider to complete the add-on service. The service provider visits the store later that day, completes the add-on service for said product according to the customization request ordered by the customer. The service provider calls and/or informs the customer to let him/her know that the product is ready to pick up. The customer picks up the enhanced product from the store the next day.

Because the LeafBill and the Leaflet includes the service provider's customer support information, the customer can reach out to the service provider if he or she needs further customization or needs customer support for that add-on component and/or service.

Essentially, LeafBill encloses the transactions of add-on components and services into on bill and one transaction, so that more refined customer service and add-on components and/or services can be delivered to individual customers.

Illustrated in FIG. 17B, a barcode 1710 is shared on both the service provider side 1702 and the consumer side 1706 of the Leaflet 1700. The make the comparison, verification of the Leaflet easier, and also increases the security and reliability of LeafBill. The barcode can also include other information such as the location of the store, and the type of the add-on component and/or service.

With reference to FIG. 17, an embodiment for implementation of a virtual fitting system, such as virtual fitting system 1800, make available on an electronic device, is used to assist the customer to virtually try on the add-ons and/or products and make their purchase decision. The customer use the system to take a picture of their personal space, add images of products 1808, and images of add-on components and/or services 1802 on top of said photo, so that they can visualize how an add-on pillow 1802 looks with a generic sofa 1808, and how this sofa and pillow set looks in their living room on the graphic display area 1810 of said virtual fitting system. When the customer select the add-ons, the system automatically calculates the total price 1804 that includes the add-on 1802 and the base product 1806. The customer can print out the LeafBill receipt by click on the Get Receipt button 1812, or order the generic product and add-ons from their provider in one purchase by click on the Order and/or Buy button 1814.

### The Benefit

### Part 15: Benefits of LeafBill

LeafBill helps stores to benefits from the creativity and specialty offered by individual service providers, and receives profits from the sell.

LeafBill helps stores to sell enhanced products at higher prices, attract customers and increase store sales.

LeafBill helps service providers to have a reliable way to instill their creativity and specialty on top of generic products, an efficient way to display these enhanced products and make them available to sell, and receive benefits from the sells of these add-on components and/or services. This effectively transfers their creativity and specialty into income generating resources for them; at the same time, offers enhanced services and better products for the consumers.

LeafBill is very flexible. A store owner may decide to sell generic products in his/her store, along with enhanced products using LeafBills. LeafBills can integrate easily with tradition Point Of Sale systems, and check out machines. A store owner can adapt with LeafBill based on his/her own pace on learning new technology, personal comfort zone, education level, technology savvy level, desire to change and other criteria.

Service providers may have their own boutique stores. Or several service providers may jointly own a store, have their enhanced products on display and make available to sell, and take turns to work at the store and provide enhanced services to the customers.

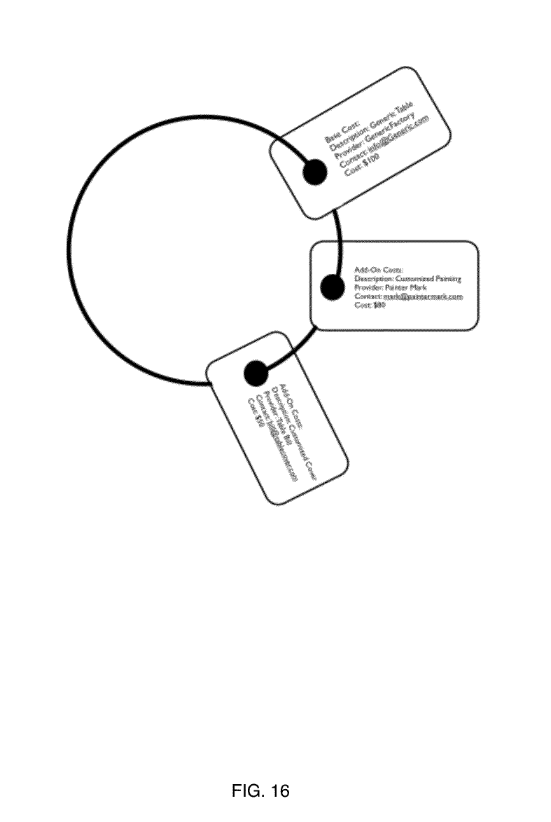

LeafBill is easy to implement. FIG. 16 shows a hand-made LeafBill. Individual services providers has Leaves for their add-on components and/or services. Working with the store owner, they add their add-on components and/or services on top of the generic products, and add their leaves to the Stem of the LeafBill. It is like add another key to a key chain. It is a flexible, easy and visible way to include add-ons as part of a product, display said added value, and receive compensation for the added value upon the sell of the product.

LeafBill is a transparent and visible way to display the additional enhancement and/or work instilled onto the product. This is ensures that service providers will try to provide high quality work as add-on components and/or services of the product. Because they get paid for their add-ons, the quality, uniqueness, style and other attributes of their add-ons directly decides whether customers will buy their add-ons as part of the product. It is also highly visible to the consumers who provides which add-on component and/or service. Consumers may become loyal customers for particular service providers, because the match in their style and taste, or because of the quality of the work, or because on-going services, or because the inter-personal skill of the service provider and etc.

LeafBill creates a sale point where in-personal, one-on-one relationship is established between a service provider and a customer. This helps the service provider to offer personalized and customized services to the customer. It also in general, helps our society to become a better communicated, integrated community.

For the store owners, because LeafBill helps them to offer enhanced products to the customers, they can sell products at a higher price and get higher profit margin. They may also get profit and/or commission out of the sell of the add-on components and/or features. This creates incentives for the store owners to attract and maintain a healthy amount of service providers partnering with the store, and work at the store.

For the consumers, LeafBill enables them to get customized products and/or services tailored to their preferences. It makes shopping a much more interesting experience. For the customers, buying a product and receiving high quality tailored consumer services is equally important and valuable.

LeafBill provides transparent and visible way to display the contributors of a product and their compensation at Time Of Sell. Consumers are clearly aware of what they are paying for, and who receives which portion of the pay off from the sell. This creates an organic way to create a healthy transaction flow for the local economy.

Like the “Buy Local, Buy Organic” campaign, consumers have an increasing awareness and conscious on contributing to their local community, and maintain a healthy local economy. Knowing that they are paying for high quality of service provided by individual local service providers, who can provide regular, on-going customized services to them in-person, incent them to pay a higher price for the enhanced product with add-on components and/or services.

LeafBill also provides an easy, visible, organic and effective way to monitor the proper usage of LeafBill. Each Leaf clearly identifies the service provider and its add-on component and/or feature. Consumer can clearly identifies what are the add-on component and/or feature that they have included in their purchase, and who get paid for that add-on at the check out. The LeafBill includes the contact information and/or customer support contact of the service provider, customer can send their feedback to the service provider, and communicate with the service provider.

Since the service providers do not offer the entire product, but instead, provide specific add-on components and/or services to the products, tailored to a specific consumer group, based on their style and taste. They are not competing with the retailers for their product line, distribution channel and/or retail stores. Just like artists are not competing with galleries, but instead they depends on each other. The relationship between service providers and store owners shall also be a mutual beneficial partnership, and creates a win-win solution for both parties.

While this invention has been described in terms of a preferred embodiment, there are alterations, permutations, and equivalents that fall within the scope of this invention. It should also be noted that there are many alternative ways of implementing both the process and apparatus of the present invention. It is therefore intended that the invention be interpreted as including all such alterations, permutations, and equivalents as fall within the true spirit and scope of the present invention.

Although the invention is described herein with reference to the preferred embodiment, one skilled in the art will readily appreciate that other applications may be substituted for those set forth herein without departing from the spirit and scope of the present invention.

This knowledge and this invention is documented here so that it can be properly preserved and shared among people who may use this knowledge to improve their lives and other people's lives. It is my intent that people may use this knowledge, improve it, and use it to benefit our society. So that our system can improve, our living conditions as human beings can improve in general, and people can have better lives. This is under the fundamental principle, that we, human beings, shall proliferate and prosper as a society.

What is claimed is:

1. A system for offering customized add-on components and services to customers and receive payment for said add-ons, comprising:
a. component(s) to display add-on component(s) and/or service(s) and their associated cost(s) to consumers;
b. means for said consumer to browse through a plurality of said add-ons; and
c. means for said consumer to select add-on component(s) and/or service(s); and consolidate them into one purchase; and
d. means for said consumer to input detailed customization request and/or service request for said add-on component(s) and/or service(s); and
e. means for said consumer to pay for said enhanced product along with said selected add-on(s) in one transaction; and
f. means for said consumer to receive receipt(s) for paid enhanced product as well as the paid add-on(s) and
g. means for individual service providers who provide these add-on(s) to provide on-going customer support for said consumer(s); and
h. means for said system to include barcode, encryption methods, logos, images and/or a combination of them, to offer easy and secure transactions.

2. A system for virtual fitting and select add-ons in accordance with claim 1, where in said consumer can use an electronic device to virtually try on and/or fit a plurality of his/her photos to a plurality of add-on component(s) and/or service(s); visualize the result(s) of said add-on component(s) and/or service(s) on top of the product, and how that enhanced product looks on him/her or in his/her personal environment; select the add-on(s) based on his/her personal preferences; use said system to order and purchase said enhanced product along with the selected add-on component(s) and/or service(s).

3. A system for offer add-on services and receive payments through price segmentation, comprising:
a. a base pricing component (Stem);
b. add-on pricing component(s) (Leaf); and
c. parts to connect the add-on(s) with the base pricing component (Petiole); and
d. a form or structure to hold these components together (LeafBill), to make it into an easily adjustable system; and
e. means for said system to include barcode, encryption methods, logos, images and/or a combination of them, to make it into a secure and reliable system.
